(19) United States
(12) Patent Application Publication
(10) Pub. No.: US 2009/0173639 A1
(43) Pub. Date: Jul. 9, 2009

(54) WATER DRAINING SYSTEM FOR A FUEL FILTER

(76) Inventors: Lana Ferrari, West Yorkshire (GB); Phil Core, West Yorkshire (GB)

Correspondence Address: CHRISTOPHER H. HUNTER, PARKER-HANFIN CORPORATION, 6035 PARKLAND BOULEVARD, CLEVELAND, OH, 44124-4141, US

(21) Appl. No.: 12/369,836

(22) Filed: Feb. 12, 2009

Related U.S. Application Data
(63) Continuation of application No. PCT/GB2007/003137, filed on Aug. 16, 2007.

(30) Foreign Application Priority Data
Aug. 17, 2006 (GB) 0616465.1

(51) Int. Cl. C02F 1/461

(52) U.S. Cl. 205/743; 210/86; 210/744

(57) ABSTRACT

A water draining system for a fuel filter having a water collecting reservoir is disclosed. The water draining system has a housing adapted for attachment to the reservoir, the housing having a water sensor arranged to protrude into the reservoir and having a valve with an inlet for draining water collected in the reservoir. The valve is selectively moveable between an open and a closed configuration. The water draining system also has a controller connected to the sensor such that when the water level in the reservoir reaches a predetermined level, the sensor sends a signal to the controller and movement of the valve between the open and closed configuration is directly or indirectly dependent upon subsequent signals generated by the controller.

### CROSS REFERENCE TO RELATED APPLICATIONS

This application is a continuation of copending International Application No. PCT/GB2007/003137, filed Aug. 16, 2007, which designated the United States, the disclosure of which is incorporated herein by reference, and which claims priority to Great Britain Patent Application No. 0616465.1, filed Aug. 17, 2006.

### FIELD OF THE INVENTION

The present invention relates to water draining systems for fuel filters. It has been developed primarily as a device for sensing and draining water collected in a fuel filter and will be described hereinafter with reference to this application. However, it will be appreciated that the invention is not limited to this particular field of use.

### BACKGROUND

Fuel systems in automotive engines generally include a fuel filter system which removes water and other contaminants from fuel. It is common for primary fuel filters to have a water collecting compartment and a manually operable drainage valve.

Drainage of water compartments can pose many challenges. For example, if a water compartment does not have an easily visible water level indicator, a driver or mechanic is reduced to draining the compartment on a periodic basis, as there is no way of identifying when the compartment requires draining.

Draining on a periodic basis is very inaccurate and can result in the compartment being drained even though the process is not required. Alternatively, if the water level rises at a greater rate than predicted, the compartment may become full and any additional water may not be filtered from the fuel.

This is problematic because if the filtration of water in an engine is inefficient, the water may work its way into the lubricated moving parts of an engine, and this will cause corrosion and unnecessary wear. Hence the working life of the engine's fuel system components, such as pumps and injectors, may be substantially reduced.

A known type of drainage system developed to overcome the above disadvantages involves use of a transparent water compartment with a water level marker. The transparent compartment allows the driver to visually see when the water level reaches the marker and hence, the driver knows that the reservoir requires draining.

Whilst this apparatus does remove the need for periodic draining, the device is only effective so long as the driver remembers to physically check the water level and drain the compartment at the appropriate time.

In order to overcome the need for a driver to physically check the water level, other systems have been developed which include a water level sensor located within the fuel filter system. The sensor can send a signal to an operating panel to indicate to a driver that the compartment requires draining.

Although this device overcomes the need for physically checking the water level of a filter system, a driver or mechanic is still required to physically drain the water compartment.

This can be problematic as quite often, due to space restrictions and awkward positioning of the drainage valve within the engine cavity, manual drainage can be a time consuming process. Furthermore, if a driver is unable to drain the compartment themselves, the vehicle must be taken to a mechanic and hence the vehicle could be out of service for some time, depending on the availability of a mechanic.

Additionally, if the water sensor is the type which is activated by water coming into contact with a pair of metal sensor elements having a current running through them, the longer the sensors are in contact with the water, the higher the risk of corrosion. Typically, a sensor is expected to have a working life of no less than 200 hours if constantly submerged in water. However this can be significantly reduced, for example to approximately 48 hours, dependent on factors such as, the level of electrical current applied to sensor in water, the water PH level, or contaminants present in fuel system.

Therefore, if the water filter can not be emptied within a relatively short period of time, the water sensor may need replacing. Again, this may result in the vehicle being out of service for an unknown period of time, depending on the availability of parts and labour.

It is an object of an embodiment of the present invention to overcome or ameliorate at least one or more of the disadvantages of the prior art, or at least provide a useful alternative.

It is an object an embodiment of the invention, at least in a preferred form, to provide a fuel filter system which allows relatively quick and efficient drainage of a water collecting compartment. Other embodiments may also provide a water sensor which is less susceptible to corrosion when in contact with water.

### SUMMARY OF THE INVENTION

According to a first aspect of the invention there is provided a water draining system for a fuel filter having a water collecting reservoir, where the system is adapted to have an automatic mode of operation or a semi-automatic mode of operation. The system includes a housing adapted for attachment to the reservoir. The housing has a water sensor arranged to protrude into the reservoir and a valve with an inlet for draining water collected in the reservoir. The valve is selectively movable between an open and a close configuration.

A controller is connected to the sensor such that when the water level in the reservoir reaches a predetermined level, the sensor sends a signal to the controller and movement of the valve between the open and closed configuration is automatically or semi-automatically dependent upon subsequent signals generated by the controller, such that: i) in the automatic mode, upon the controller receiving the signal from the water sensor, the controller sends a signal which automatically moves the valve into the open configuration, allowing water to drain from said reservoir; and

ii) in the semi-automatic mode, upon the controller receiving the signal from the water sensor, the controller sends a signal which activates a warning indicator on an operating panel to indicate to an operator that the reservoir requires draining and the controller is adapted to send a signal to move said valve into the open configuration upon receiving a signal from valve activation means, the valve activating means being arranged to be manually triggered by an operator.

Preferably, the valve is a self-venting solenoid valve resiliently biased into the closed configuration.

The valve activation means is preferably a switch or button located on a control panel inside a vehicle cabin. When the operation activates the valve activation means, and the controller sends a signal to move the valve into the open configuration. The controller may also send a signal to deactivate the warning signal on the operating panel. The controller may then send a signal to return the valve to the closed configuration after a first predetermined period of time.

Once the first predetermined period of time has expired and the valve returns to the closed configuration, the controller may be programmed to wait for a second predetermined period before allowing the valve to reopen and the cycle to repeat

Preferably, the first time period is approximately 15 seconds and the second time period is approximately 6 minutes.

The water sensor preferably comprises a pair of sensing elements having a voltage running therethrough. Preferably, the proximal ends of the elements protrude into the housing and the distal tips of the elements protrude into the reservoir so that when the water in the reservoir rises to the predetermined level, this allows the water to simultaneously contact the tips and a current to pass therebetween, causing a drop in resistance across the sensor tips which generates an signal from the water sensor.

Preferably, upon the controller is reading a predetermined range of resistance across the sensor tips, the controller subsequently reduces the current running therethrough. The resistance reading preferably required to generate the signal to lower the current is in the range of 0 to 47 K Ohms. The current across the tips is preferably reduced from approximately 10 mA to less than 1 mA.

The controller is preferably an engine control unit (ECU) or a printed circuit assembly (PCA).

In embodiments including a PCA, the PCA may be connected to an ECU which is connected to the operating panel so that signals generated by the PCA are relayed to the operating panel via the ECU. Furthermore, the signals sent from the operating panel to the valve may be sent via the ECU.

Embodiments of the invention may also include a water sensor with distal sensor tips formed from titanium with a suitable mixed metal oxide (MMO) coating.

In embodiments including a self-venting solenoid valve, the valve preferably includes a solenoid coil, a solenoid stem, a solenoid armature and a piston rod connected to the armature. Preferably, supplying a current to the coil moves the armature towards the stem which moves the rod such that the valve moves into the open configuration. More preferably, when the controller allows a current to pass through the coil, the valve moves into the open configuration. The valve may then return to the closed configuration when the controller ceases to provide a current to the coil.

Preferably, the reservoir is coupled to the housing and one side of the housing forms part of the base of the reservoir.

More preferably, the housing includes a sensor retaining module adapted for retaining a portion of the distal tips. The enclosed portion of the tips is preferably shielded from contact with the water and the exposed portion of the tips preferably does not come in contact with the water until the predetermined level is reached.

Preferably, the retaining module protrudes into the reservoir and the length of the protrusion is directly proportional to the predetermined level of water required to activate the signal generated by the sensor tips.

Embodiments of the housing may include a water sensor retaining component and a valve retaining component coupled together. Preferably, the housing includes a recess for accommodating the PCA. This recess is preferably located within the water sensor retaining component of the housing.

Combining the water sensor and valve in the same housing is advantageous over the prior art as this forms a more compact water drainage system which takes up relatively less space in the engine cavity.

Additionally, it has been found that reducing the level of current running through the sensors can substantially reduce the likelihood of corrosion after the tips come in contact with water. Hence, if the water level rises to the predetermined level and an operator is unable to drain the water from the reservoir within a relatively short period of time, reducing the current allows the driver additional time to have the reservoir drained without sustaining substantial damage to the water sensor.

According to a second aspect of the present invention there is provided a method of draining water from a fuel filter in a water drain system, wherein a sensor senses when a water level in a reservoir reaches a predetermined level and the sensor sends a signal to a controller when the water level in the reservoir has reaches the predetermined level. A valve is opened to drain water collected in the reservoir either automatically or semi-automatically upon receipt of the signal, wherein when the system is in said automatic mode, the controller receives the signal from the water sensor and sends a signal which automatically moves the valve into the open configuration; and when the system is in the semi-automatic mode, the controller receives the signal from the water sensor and sends a signal to activate a warning indicator on the operator panel to indicate to the operator that the reservoir requires draining and the operator activates the valve activation means to open said valve.

### BRIEF DESCRIPTION OF THE DRAWINGS

Preferred embodiments of the invention will now be described, by way of example only, with reference to the accompanying drawings in which:

FIG. 1 is a cross-sectional side view of a self-venting solenoid valve;

FIG. 2 is a perspective view of a water draining system for a fuel filter in accordance with one embodiment of the invention;

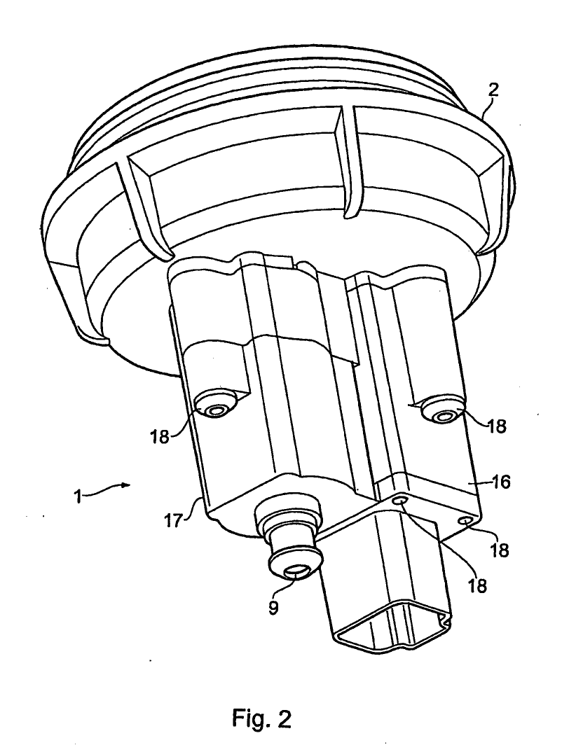

FIG. 3 is an exploded perspective view of the water draining system of FIG. 2, shown with the reservoir disconnected from the housing;

FIG. 4 is a cross-sectional perspective view of the water draining system, taken on line 4-4 of FIG. 1;

FIG. 5 is a cross-sectional perspective view of the water draining system, taken on line 5-5 of FIG. 1;

FIG. 6 is an exploded perspective view of the water draining system of FIG. 1 (reservoir not shown);

FIG. 7 is a flow diagram showing an example of semi-automatic drainage where the signal to the operator is relayed by an ECU and the current reduction to the sensor tips is controlled by a PCA;

FIG. 8 is a flow diagram showing an example of semi-automatic drainage where the signal to the operator is relayed by an ECU and the current reduction to the sensor tips is controlled an ECU;

FIG. 9 is a flow diagram showing an example of semi-automatic drainage where the signal to the operator is relayed by a PCA and the current reduction to the sensor tips is controlled by a PCA;

FIG. 10 is a flow diagram showing an example of fully-automatic drainage where the signal to the operator is relayed by an ECU and the current reduction to the sensor tips is controlled by a PCA;

FIG. 11 is a flow diagram showing an example of fully-automatic drainage where the signal to the operator is relayed by an ECU and the current reduction to the sensor tips is controlled by an ECU; and

FIG. 12 is a flow diagram showing an example of fully-automatic drainage where the signal to the operator is relayed by a PCA and the current reduction to the sensor tips is controlled by a PCA.

### PREFERRED EMBODIMENT OF THE INVENTION

Referring to the drawings, the water draining system includes a housing 1 and a reservoir 2 mounted to the housing for collecting water from a fuel filter (not shown).

The housing includes a water sensor 3 with its distal end protruding into the reservoir 2 and its proximal end protruding into the housing 1. The proximal end is connected to a controller which is located either inside or outside the housing. The controller is connected to a power source, such as a battery.

In one embodiment, the water sensor includes a pair of sensing elements 4 having a voltage running therethrough. The distal tips of the sensing elements 4 protrude through one end of a sensor retaining module 5 and the proximal ends of the sensing elements 4 extend into the inner space of housing 1. The retaining module 5 prevents the un-exposed portion of the tips from coming in contact with any water contained in the reservoir 2.

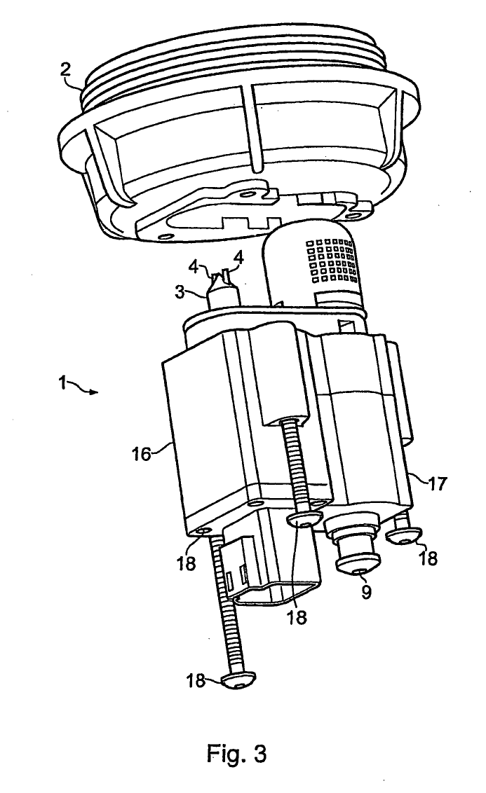

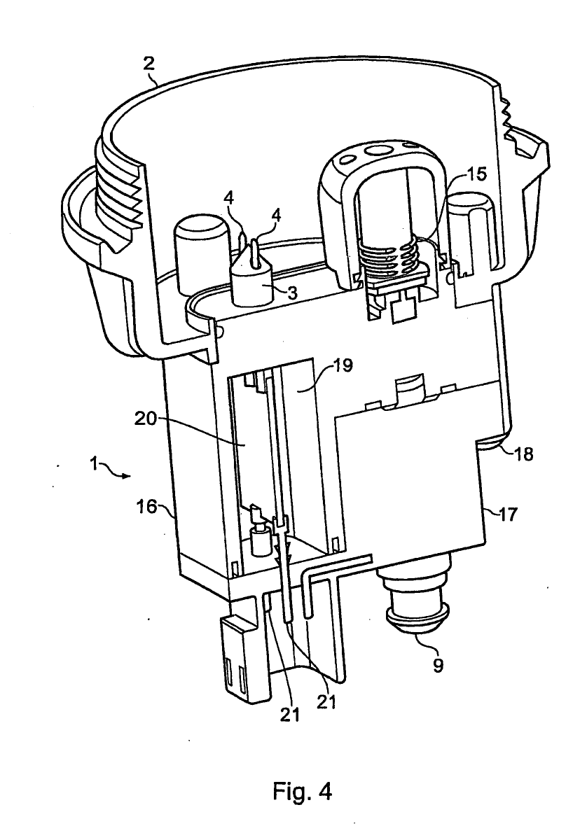

Preferably, the reservoir 2 is coupled to one side of the housing 1 and this forms part of the base of the reservoir. The sensor retaining module 5 is also preferably integrally formed with the housing, as best shown in FIGS. 3 and 4.

The water level required to activate the sensor can be set by increasing or decreasing the height of the retaining module 5. For example, the greater the height or protrusion of the module 5 into the reservoir 2, the more water that can be collected before activating the water sensor 3.

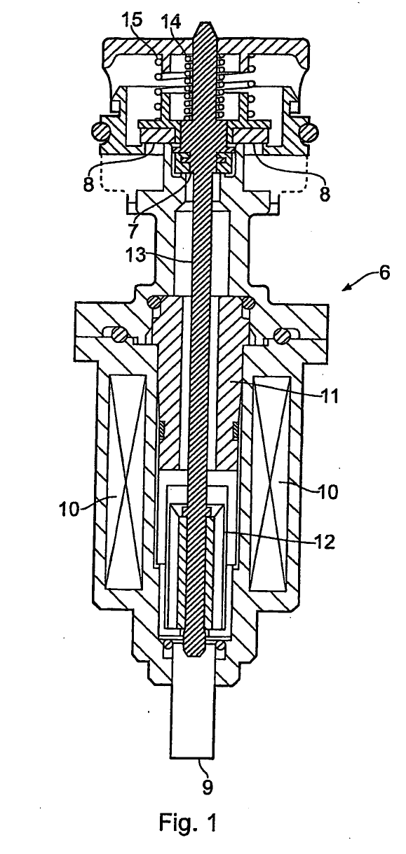

The housing also includes a valve 6. The valve is preferably a self-venting solenoid valve similar to that disclosed in patent reference WO 2004/007942 (Parker Hannifin (UK) Limited) and depicted in FIG. 1.

Use of self-venting valves allows water to be drained in conditions where there is no pressure present a system, which is often the case with devices located on the suction side of a fuel engine system.

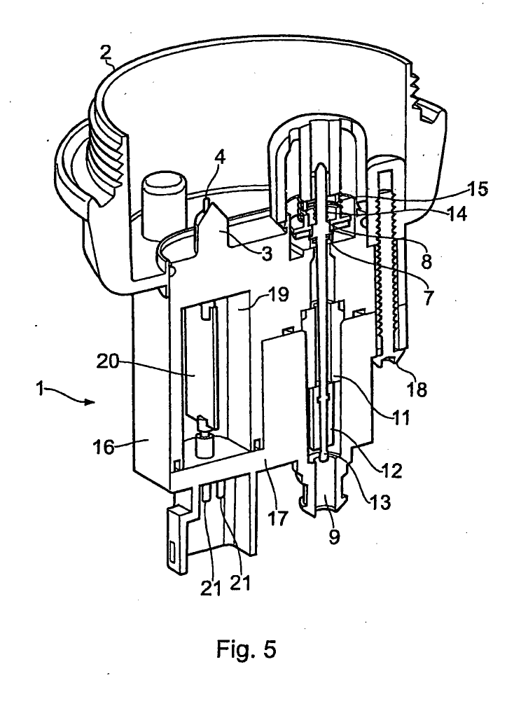

As best shown in FIGS. 1 and 5, the valve 6 includes a drain inlet 7, an air inlet 8 and a drain outlet 9. The drain inlet 7 is adapted to receive fluid from the reservoir 2.

The valve also includes a solenoid coil 10, a solenoid stem 11 and a solenoid armature 12. The solenoid armature is connected to a piston rod 13. Movement of the rod 13 allows the valve to move between a closed configuration where the drain inlet 7 and the air inlet 8 are sealed, and an open configuration where the drain inlet 7 and air inlet 8 are open. The valve is resiliently biased into the closed configuration by inner and outer springs 14 and 15 acting on the rod 13. Movement of the rod 13 is dependent on activation and deactivation of the coil 10.

When the coil 10 is activated, it creates a magnetic field which magnetises the stem 11 and armature 12. This magnetic field pulls the armature 12 towards the stem 11, subsequently compressing inner and outer springs 14 and 15 and causing axial movement of the rod 13 which opens the drain inlet 7 and air inlet 8. This in turn allows the water to drain from the reservoir 2.

Once the coil 10 is deactivated, the inner and outer springs 14 and 15 return the rod 13 to its initial position, closing the drain inlet 7 and air inlet 8.

In embodiments where a self-venting function is not required, the valve described above can be modified by blocking the air inlet 8 and removing the outer plunger and outer spring 15.

It may be appreciated by those skilled in the art that other types of valve can be used to facilitate the drainage of the reservoir 2.

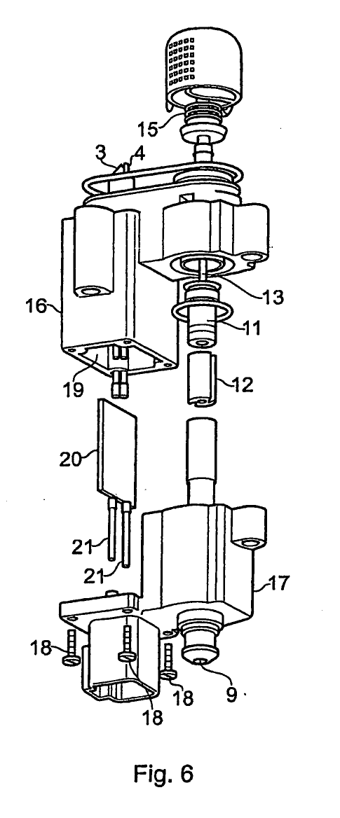

The housing 1 also includes a water sensor retaining component 16 and a valve retaining component 17 coupled together by screws 18 to form an integrated housing unit, as best shown in FIG. 6. Included in the water sensing retaining component 16 is a recess 19 for accommodating a controller such as a printed circuit assembly (PCA) 20.

In the embodiment shown in FIG. 5, the proximal ends of the sensor elements 4 are attached to the PCA 20 and the PCA is attached to connector pins 21. However, in embodiments not including a PCA, the proximal ends may be attached directly to the connector pins 21.

The connector pins 21 may be connected to an operating panel located in the cabin of a vehicle. Alternatively, the connector pins may be connected to an electronic management unit (not shown) such as an engine control unit (ECU).

An ECU is typically an onboard computer system that monitors the outputs and controls the inputs of an automotive system. An ECU gathers data from the sensors within the system and uses this information to regulate various engine components as required.

In use, water is filtered from the fuel via the fuel filter system and collected in the reservoir 2. When the water in the reservoir 2 rises to a level where it simultaneously contacts the electrified tips of the elements 4, this allows a current to pass in between. The controller is programmed to note when there is a significant drop in resistance and this information is used to indicate that the water reservoir 2 requires draining.

An example of the range of the resistance required to activate a signal to the controller is between 0-47 K Ohms. Hence, if the resistance is greater than the programmed range, the controller will not relay any signal and the valve will remain closed.

Upon receiving the signal that the reservoir requires draining, the controller may act in a variety of direct or indirect ways to allow fully-automatic or semi-automatic drainage of the water level of the reservoir.

In fully-automatic drainage, once the controller registers that a predetermined drop in resistance has occurred, it directly sends a signal to open the valve. Whereas in semi-automatic drainage, the water drainage system includes a valve activation means which may be activated by an operator upon observing a warning light on an operating panel.

In both fully-automatic and semi-automatic drainage, the controller may also lower the current flowing through the sensor tips. This drop in current substantially reduces the corrosion rate of the tips of the sensors elements 4, which increases the service life of the sensor tips and reduces the likelihood of needing to replace the water sensor. Typically the drop in current is from approximately 10 mA to less than 1 mA.

The tips of the sensor elements 4 may alternatively be protected from corrosion by being formed from a corrosive resistant material, such as titanium. The titanium must be covered in a suitable MMO coating in order to break the high resistance of titanium in water and allow a current to pass between the tips. In embodiments utilising corrosion resistant tips, there is no need for the controller to lower the current running through the tips.

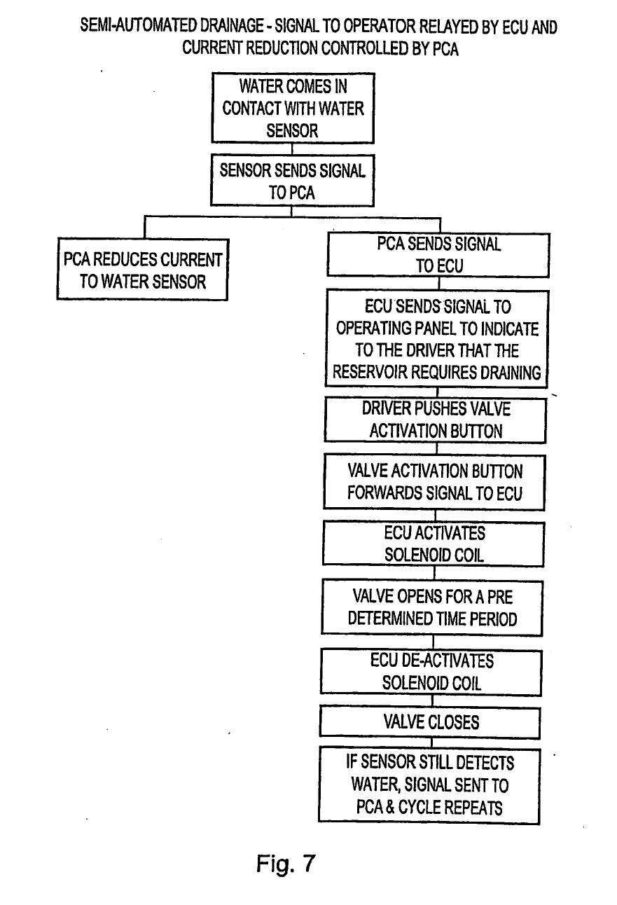

Examples of semi-automatic drainage are shown in FIGS. 7 to 9.

FIG. 7 shows an embodiment of semi-automatic drainage where the signal to the operating panel is relayed by an ECU and the reduction in current to the sensor tips is controlled by a PCA.

Once the water comes in contact with the sensor tips, this creates a significant drop in resistance which is read by the PCA. The PCA then forwards a signal to the ECU which sends a signal to the operating panel to indicate to the driver that the reservoir 2 requires draining. The signal to the driver may be in the form of a warning light on the operating panel within the cabin of the vehicle. The PCA may also simultaneously reduce the current flowing through the sensor tips.

Once the driver is alerted that the reservoir requires draining, he/she applies the valve activation means which forwards a signal to the ECU. The ECU then allows a current to pass through the solenoid coil 10 which moves the rod 13 and opens the valve 6.

After a designated period of time, the ECU discontinues the current flowing through the coil 10 and the valve 6 returns to its closed configuration.

If there is still water in the reservoir, after a designated time period the ECU will check if there is still a drop in resistance across the sensor tips and if so, the drainage cycle will repeat.

During drainage, the current passing through the solenoid generates a significant amount of heat. The ECU is programmed to include a ‘cooling off’ time between cycles so that overheating of the system can be avoided. For example, if the valve is open for 15 seconds, a 6 minute cooling off period is applied.

Alternatively a “hit and hold” voltage function can be introduced through either the ECU or PCA to ensure that valve does not overheat. An example of the “hit and hold” voltage function involves the controller applying say 24V to the valve for 100 msec, then reducing it to say 9V for another 14 sec or longer, depending on how long valve is required to drain water. In this instance, the 6 minute “cooling off” period could be reduced to say 1 minute. In some cases, no cooling off period may be required at all.

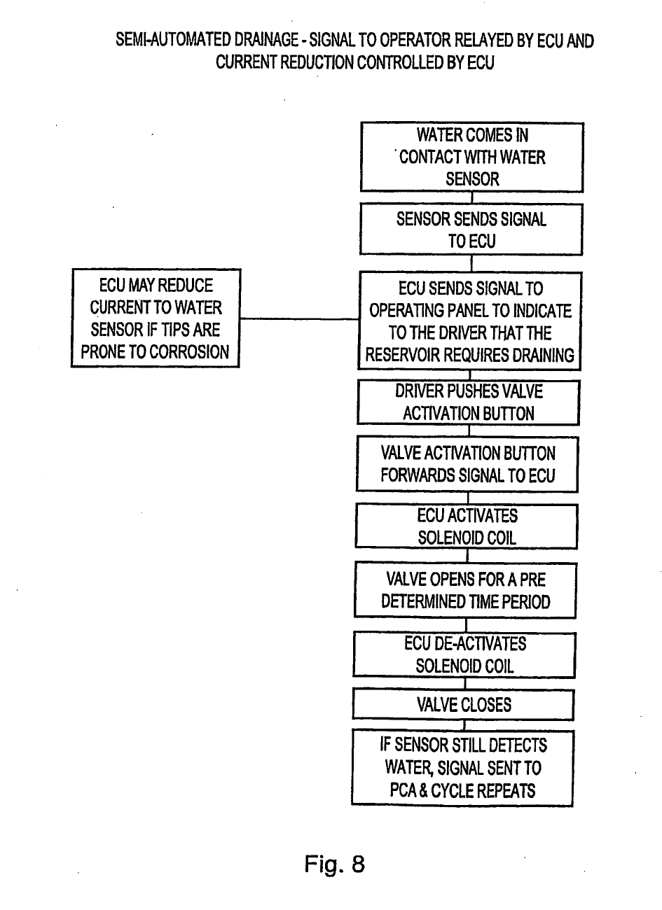

FIG. 8, shows a semi-automatic system which is similar to FIG. 7, except the resistance drop across the sensor tips is monitored directly by the ECU and it also controls the lowering of the current level across the sensor tips.

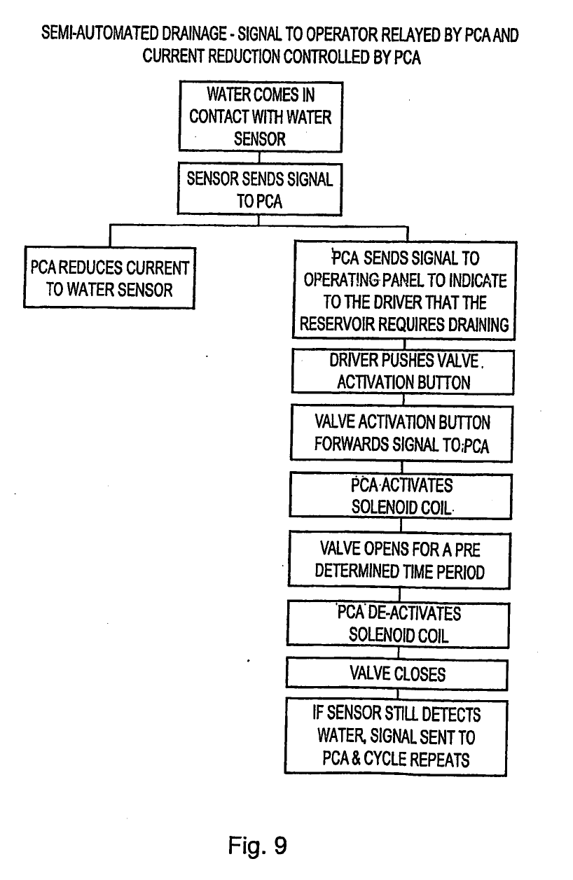

FIG. 9, shows a similar semi-automatic system to that of FIG. 7, except the PCA sends a signal directly to the operating panel, rather than via an ECU. Furthermore, it is the PCA which controls the length of time the valve is in the open and closed configurations.

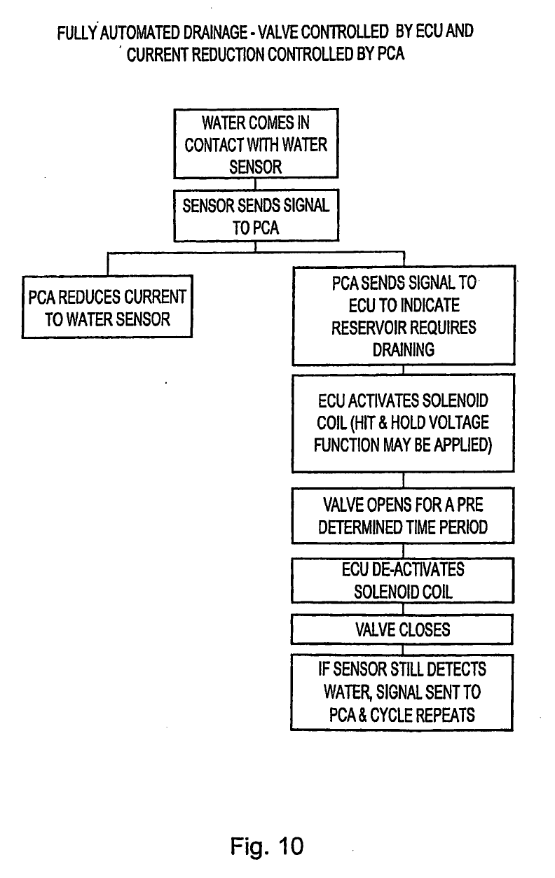

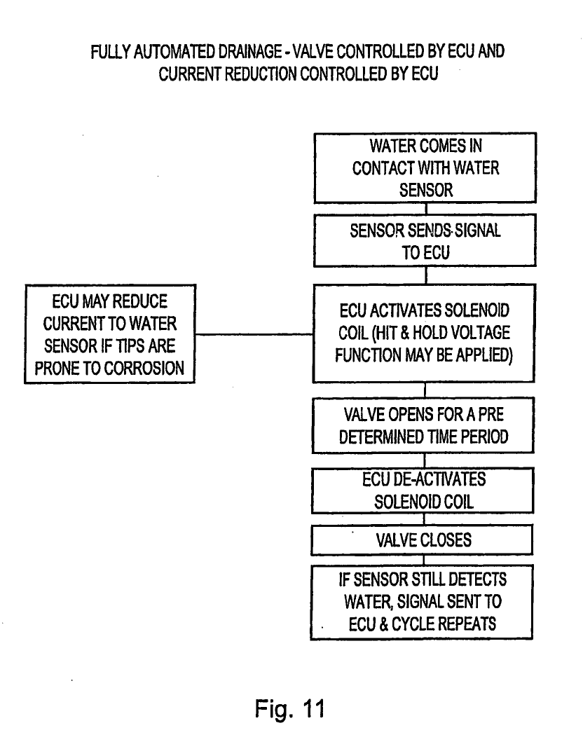

Examples of fully-automatic drainage are shown in FIGS. 10 to 12. These examples substantially correspond with FIGS. 7 to 9 respectively, the only difference being that instead of the controller sending a signal to an operating panel to alert a driver that the reservoir requires drainage, this step is bypassed and the controller sends a signal to directly activate the solenoid coil 10 and move the valve into the open configuration.

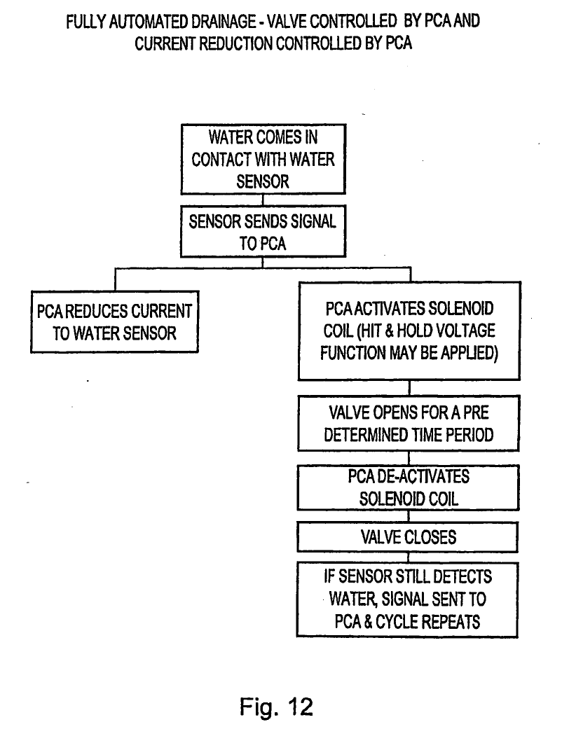

An advantage of the system shown in FIG. 12 is that the use of PCAs to control both the current to the tips and the current to the solenoid coil 10 allows the water drainage system to operate as a self-regulating unit. This is beneficial, as use of the PCA in this way removes the need to burden the ECU with an additional task.

It will be appreciated that the illustrated water draining device provides a fuel filter system which allows relatively quick and efficient drainage of a water collecting reservoir. Embodiments also provide a water sensor which is less susceptible to corrosion when in contact with water.

Although the invention has been described with reference to a specific example, it will be appreciated by those skilled in the art that the invention can be embodied in many other forms.

What is claimed is:

1. A water draining system for a fuel filter having a water collecting reservoir, said system adapted to have an automatic mode of operation or a semi-automatic mode of operation, said system including:
a housing adapted for attachment to said reservoir, said housing having a water sensor arranged to protrude into said reservoir and having a valve with an inlet for draining water collected in said reservoir, said valve being selectively movable between an open and a closed configuration;
a controller connected to said sensor such that when the water level in said reservoir reaches a predetermined level, said sensor sends a signal to said controller and movement of said valve between said open and closed configuration is automatically or semi-automatically dependent upon subsequent signals generated by said controller such that:
in said automatic mode, upon said controller receiving said signal from said water sensor, said controller sends a signal which automatically moves said valve into said open configuration, allowing said water to drain from said reservoir; and
in said semi-automatic mode, upon said controller receiving said signal from said water sensor, said controller sends a signal which activates a warning indicator on an operating panel to indicate to an operator that said reservoir requires draining; and said controller is adapted to send a signal to move said valve into said open configuration upon receiving a signal from valve activation means, said valve activation means arranged to be manually triggered by an operator.

2. A water draining system according to claim 1 wherein said valve is resiliently biased into said closed configuration.

3. A water draining system according to claim 1, wherein said valve activation means is a switch or button located on a control panel inside a vehicle cabin.

4. A water draining system according to claim wherein when an operator activates said valve activation means, said means sends a signal to said controller and said controller sends a signal to move said valve into said open configuration.

5. A water draining system according to claim 4, wherein said controller is programmed to send a signal to return said valve to said closed configuration after a first predetermined time period.

6. A water draining system according to claim 5 wherein once said predetermined first time period has expired and said valve returns to said closed configuration, said controller is programmed to wait for a second predetermined time period before allowing said valve to reopen.

7. A water draining system according to claim 6 wherein said first predetermined time period is approximately 15 seconds and said second predetermined time period is approximately 6 minutes.

8. A water draining system according to claims 1, wherein said controller stores information regarding valve activation which is subsequently recoverable by a technician.

9. A water draining system according to claim 4 wherein when the operator activates said valve activation means and said valve activation means sends a signal to said controller to open said valve, said controller deactivates said warning signal on said operating panel.

10. A water draining system according to any claim 1 wherein said water sensor comprises a pair of sensing elements arranged to have a voltage running therethrough, wherein the proximal ends of said elements protrude into said housing and the distal tips of said elements protrude into said reservoir such that said predetermined rise in the water level in said reservoir facilitates said water to simultaneously contact said tips and a current to pass therebetween, causing a drop in resistance across the sensor tips and generating said signal from said water sensor.

11. A water draining system according to claim 10 wherein upon said controller reading a predetermined range of resistance across said sensor tips, said controller subsequently generates a signal to reduce said current running through said tips.

12. A water draining system according to claim 11 wherein said resistance reading required to generate said signal to lower said current is in the range of 0 to 47 K Ohms.

13. A water draining system according to claim 11 wherein said current is reduced from approximately 10 mA to less than 1 mA.

14. A water draining system according to claim 1, wherein said controller is an engine control unit (ECU).

15. A water draining system according to claim 1, wherein said controller is printed circuit board (PCA).

16. A water draining system according to claim 15 wherein said PCA is connected to an ECU which is connected to said operating panel such that signals generated by said PCA are relayed to said operating panel via said ECU.

17. A water draining system according to claims 10, wherein said sensor tips are formed from titanium with a suitable MMO coating.

18. A water draining system according to claim 1, wherein said valve is a self-venting solenoid valve.

19. A water draining system according to claim 18 wherein said solenoid valve includes a solenoid coil, a solenoid stem, a solenoid armature and a piston rod connected to said armature wherein supplying a current to said coil moves said armature towards said stem which moves said rod such that said valve moves into said open configuration.

20. A water draining system according to claim 19 wherein said valve moves into said open configuration when said controller allows a current to pass through said coil.

21. A water draining system according to claim 10 wherein said valve returns to said closed configuration when said controller stops said current passing through said coil.

22. A water draining system according to claim 1, wherein said reservoir is coupled to said housing such that one side of said housing forms part of the base of said reservoir.

23. A water draining system according to claim 10, wherein said housing includes a sensor retaining module adapted for retaining a portion of said distal tips such that the enclosed portion of said tips is shielded from contact with said water and the exposed portion of said tips do not contact said water until said predetermined level is reached.

24. A water draining system according to claim 23 wherein said retaining module protrudes into said reservoir such that the length of said protrusion is directly proportional to the predetermined level of water required to activate said signal generated by said sensor tips.

25. A water draining system according to claim 1, wherein said housing includes a water sensor retaining component and valve retaining component coupled together.

26. A water draining system according to claim 15, wherein said housing includes a recess for accommodating said PCA.

27. A water draining system according to claim 26 wherein said PCA is retained within said water sensor retaining component of said housing.

28. A method of draining water from a fuel filter in a water draining system as recited in claim 1, the method comprising:
said sensor sensing when a water level in the reservoir reaches a predetermined level,
said sensor sending a signal to the controller when the water level in the reservoir has reached the predetermined level;
opening said valve to drain water collected in the reservoir either automatically or semi-automatically upon receipt of the signal wherein;
when said system is in said automatic code, said controller receives said signal from said water sensor and sends a signal which automatically moves said valve into said open configuration; and
when said system is in said semi-automatic mode, said controller receives said signal from said water sensor and sends a signal to activate a warning indicator on the operator panel to indicate to the operator that the reservoir requires draining and said operator activates said valve activation means to open said valve.

29. A method of draining water from a fuel filter in a water draining system as in claim 10, the method comprising:
said sensor sensing when a water level in the reservoir reaches a predetermined level,
said sensor sending a signal to the controller when the water level in the reservoir has reached the predetermined level;
opening said valve to drain water collected in the reservoir either automatically or semi-automatically upon receipt of the signal wherein;
when said system is in said automatic code, said controller receives said signal from said water sensor and sends a signal which automatically moves said valve into said open configuration; and
when said system is in said semi-automatic mode, said controller receives said signal from said water sensor and sends a signal to activate a warning indicator on the operator panel to indicate to the operator that the reservoir requires draining and said operator activates said valve activation means to open said valve.

30. A method of draining water from a fuel filter according to claim 29, wherein upon receiving said signal from said water sensor, said controller lowers the voltage supplied to said sensor tips to reduce said current running through said sensor tips.
